(19) United States
(12) Patent Application Publication
(10) Pub. No.: US 2020/0012977 A1
(43) Pub. Date: Jan. 9, 2020

(54) REFINED SYSTEM-AIDED USER DEFINITION IN THE CURRENT MODELING CONTEXT

(71) Applicant: SAP SE, Walldorf (DE)

(72) Inventors: Volker Lehmann, Mühlhausen (DE); Joachim Meyer, Heidelberg (DE); Rouven Day, Waghaeusel (DE); Werner Diringer, Sandhausen (DE)

(21) Appl. No.: 16/026,406

(22) Filed: Jul. 3, 2018

(51) Int. Cl. G06Q 10/06; G06F 17/30

(52) U.S. Cl. CPC G06Q 10/0633; G06F 17/30994; G06Q 10/06311; G06Q 10/06316

(57) ABSTRACT

Techniques are described for refining system-aided user determination in the current modeling context. At runtime, operations defined in a listing of workflow steps associated with a current workflow are executed. Each step is associated with a role that is associated with the execution of the step. To execute the operations, a workflow step from the listing of workflow steps is identified. Then whether the role associated with the workflow step is a reassigned role is determined based on a reassignment indicator that is persisted in a memory associated with the role. If the role is not associated with a reassignment indicator, the workflow step is executed using a first set of users associated with the role. Otherwise, the workflow step is executed using a second set of users identified as a reassigned set of users. At design time, at least one role is reassigned via a user interface.

### BACKGROUND

The present disclosure relates to a system and computerized method for refining system-aided user definitions in a current modeling context, as well as to various operations that can be performed in combination with the refinement.

A workflow can be used as a process tool that is designed to facilitate and automate processes involving task sequences performed by the users, such as, people in a workplace. Workflows can ensure that the work is assigned in a proper sequence to the right people at the right time, enabling process owners to track deadlines, determine workloads, and provide statistics on the work processes performance. Example components of workflows include workflow definitions, work items, event triggers, an organizational structure, etc.

When modeling a workflow containing dialog tasks, potential processors can be assigned to different portions of the workflow. The assignment of users in a business workflow usually relies on either a concrete set of users for a specific workflow step (also referred to as a task) or a system-aided determination of users. The set of returned users determined based on the system-aided determination can be static or dynamic, for example, based on the workflow context. The system-aided determination may return a suitable set of users for some cases.

### SUMMARY

Implementations of the present disclosure are generally directed to refining system-aided user definition in the current modeling context. In some example implementations, a computerized method executed by hardware processors can be performed. Techniques are described for refining system-aided user determination in the current modeling context. At runtime, operations defined in a listing of workflow steps associated with a current workflow are executed. Each step is associated with a role that is associated with the execution of the step. To execute the operations, a workflow step from the listing of workflow steps is first identified. Then whether the role associated with the workflow step is a reassigned role is determined based on a reassignment indicator that is persisted in a memory associated with the role. If it is determined that the role is not associated with a reassignment indicator, the workflow step is executed using a first set of users associated with the role. Otherwise, the workflow step is executed using a second set of users identified as a reassigned set of users. At design time, at least one role is reassigned. To reassign the at least one role, a current workflow is first identified. The identified current workflow is associated with at least one workflow step, and each workflow step is associated with at least one role and a set of users assigned to that role. Next, a listing of the workflow steps associated with the identified current workflow is provided for presentation to a user interface (UI). At least one role is associated with each workflow step, and each role is assigned a first set of users. Further, a reassigned role is identified via the UI, and the reassigned role is associated with at least one workflow step from the listing of the workflow steps, and the reassigned role is reassigned by assigning a second set of users to the role to replace the first set of users that is associated with the role. Finally, the reassigned role is associated with the corresponding second set of users at a persisted storage.

The foregoing and other implementations can each optionally include one or more of the following features, alone or in combination. In particular, one implementation can include all the following features.

In some instances, to assign a second set of users to the role to replace the first set of users that associated with that role, at least one user is added or deleted from the first set of users.

In some instances, to assign a second set of users to the role to replace the first set of users that is associated with that role, the first set of users are explicitly identified as the second set of users.

In some instances, when the workflow includes a workflow instance, the workflow instance is instantiated from a workflow definition. In some of those instances, the reassignment to the workflow instance applies only to the current workflow instance and the reassignment is not propagated to other workflow instances that instantiated from the workflow definition.

In some instances, the workflow includes a workflow definition from which a plurality of workflow instances can be identified. In some of those instances, the reassignment is applied to each of the plurality of workflow instances that instantiated from the workflow definition.

In some instances, when executing the listing of the workflow steps associated with the current workflow, each workflow step is first identified from the listing of workflow steps. Then whether a role associated with the workflow step is a reassigned role is determined. If the role is not a reassigned role, the workflow step is executed according to the role and the first set of users associated with the role. Otherwise, the workflow step is executed according to the role and the second set of users associated with the role.

In some instances, the reassigned role is associated with a reassignment indicator.

In some instances, to execute the workflow step according to a role and the second set of users associated with the role, a workflow ID associated with the current workflow is first identified. Then a reassignment repository is accessed at the persisted storage. The reassignment repository includes a plurality of reassignments, and each reassignment is associated with a workflow ID corresponding to a workflow with which the reassignment is associated. Each reassignment is also associated with a reassigned role that is associated with a second set of users. Further, the reassignment associated with the same workflow ID is selected as the workflow ID associated with the current workflow. Finally, the workflow step is executed according to the role and the second set of users associated with the selected reassignment.

Similar operations and processes may be performed in a system comprising at least one process and a memory communicatively coupled to the at least one processor where the memory stores instructions that when executed, cause the at least one processor to perform the operations. Further, a non-transitory computer-readable medium storing instructions which, when executed, cause at least one processor to perform the operations, may also be contemplated. In other words, while generally described as computer implemented software embodied on tangible, non-transitory media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system 100 for executing a workflow according to reassigned roles and the users associated with the reassigned role.

FIG. 2 represents an example screenshot of a user interface 200 illustrating team member responsibility management defined by a user determination technology applied to the workflow.

FIG. 3A is an example screenshot of a user interface illustrating available determination entities (roles) and status in current context.

FIG. 3B is an example screenshot illustrating a user interface of refining (reassigning) a determination entity (role) with concrete users.

FIG. 4 is an example screenshot illustrating a user interface 400 for adding, editing, and displaying a single workflow step.

FIG. 5 represents an example flowchart for reassigning a role of a workflow in one implementation.

FIG. 6A represents an example flow illustrating a method 600 for executing a workflow with reassigned roles.

FIG. 6B represents an example flow illustrating a method 600 for executing a workflow with reassigned roles.

### DETAILED DESCRIPTION

The following detailed description describes systems and methods for refining or modifying system-aided user definition in a workflow modeling context, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted to not obscure one or more described implementations. The present disclosure is not intended to be limited to the described or illustrated implementations, but to be accorded the widest scope consistent with the described principles and features.

A workflow can contain a complete workflow definition covering several work items/tasks, and triggering events. A workflow definition is a set of rules that determines the path a process takes, specifying which actions should be performed, when these actions should be performed, and the circumstances under which these actions should be performed. For example, a set of rules that specify how a purchase order should be processed, from the initial request to the creation of a purchase order, is a workflow definition. A workflow instance, on the other hand, is a single workflow run. A workflow instance represents an executable instance or instantiation of a workflow defined by an associated workflow template. The workflow instance is an actual execution of the actions specified in a workflow definition. For example, “the process of making a single purchase order for an office printer” is a workflow instance. Therefore, by definition, a single workflow definition can have multiple workflow instances.

Tasks are the steps in the process, and the tasks can be performed either by people or automatically by the software. For example, “checking whether an office has the equipment” is a task/step for a workflow process in the previous example. A work item is the task instance that is performed as a single workflow step. For example, “checking whether there is a printer at office 5006” is a work item in this example. Tasks are linked to their possible agents.

Workflow agents can be people, either individuals or groups of people, within the system of a workflow who appear as an end user in productive workflows. The workflow agent starts workflows and processes work items. A workflow modeling user is often the managing user or administrator of an organization, and can make additional specifications about agents for a step. These specifications are evaluated at runtime by a work item manager.

When modeling a workflow containing dialog tasks, one integral part is the assignment of potential processors. The assignment of users in a business workflow may be based on either a concrete set of specific users for a specific workflow step (task) or system-aided determination of users (e.g., based on a backend association to particular steps or tasks, such as a role-based assignment where the system accesses information related to the persons or employees associated with role and associates those persons to a task where those persons are associated with the defined role). The set of returned users based on the system-aided determination can be either static or dynamic, for example, based on the workflow context.

Assignment based on a concrete set of users can be problematic because, for example, after a modeling user sets up all tasks associated with a set of concrete users at the beginning of the workflow, changes may occur in that organization causing the concrete set of persons to be incorrect or invalid. For example, one of the assigned users may not available to complete a particular task, and the work item cannot be successfully processed.

Assignment based on system-aided determination can avoid this problem by using a rule-based determination or rule set, such as a set of responsibility rules in agent determination. Thereby, if any change occurs in the organization during the process, the modeling user can execute the agent rule again and the system will dynamically identify another available user or set of users satisfying the responsibility rule for the work item. While the system-aided determination may return a suitable set of users for most use-cases, often there is a need to nevertheless influence this user determination in a particular workflow definition or workflow instance. This is especially the case when such determination technologies are centrally managed and reused in different applications. Further, the rule based system-aided user determination is not error-free. The most common cause of agent determination errors is inadequate maintenance of the agent determination rule or the authorities given to agents. Problems can also occur because an agent has left the company, or is absent for some other reason, and has no substitute, or has reserved the work item so that none of the alternative agents can access it. In addition, in case the modeling user wants to adapt the resulting users, it is very likely that other steps in the workflow need to adapt the resulting users and be processed by the same set of users as well. Therefore, for a particular workflow definition or workflow instance, a technical solution where the modeling user can explicitly decide to override the result of a system-aided determination with a concrete set of users, affecting the current modeling context (workflow definition or workflow instance) is needed. Further, a single overwriting or reassignment can be performed once and ensure that future versions of the workflow definition or instance is affected moving forward. In some instances, as well, the user determination rules may return a larger set of users than required for a current context. In those instances, to streamline a particular workflow and the persons involved, adjustment of the dynamically determined users would be helpful to adapt a particular workflow to a current contextual need.

The described solution provides a number of advantages over existing user determination technologies for a workflow. Using the described solution, for a particular workflow definition or workflow instance, the modeling user can explicitly decide to override the result of a system-aided determination with a concrete set of users to affect the current modeling context, either for all instances of a workflow definition or for specific workflow instances. Further, if the refinement of the user definition is supported by the determination technology, the result of the determination at the moment of the reassignment can be used as a starting point for further modifications. Therefore, the modification solution is applied in a limited manner to the particular and specified workflow definition or workflow instances identified by the modeling user, and the modifications affect neither other non-specified workflow definitions or workflow instances nor the determination technology itself. Thus, using the described solution, it is possible to easily revert back to the system-aided determination for upcoming workflow steps. The actual refinement can be performed by the modeling user regardless of the features of the determination engine. To obtain a prepopulated list as a starting point, the determination technology can provide an application programming interface (API) or other method of obtaining the results of the determination as resolved at the current point in time. Once obtained, additional modifications can be defined by the modeling user.

During the creation and modification of single workflow steps, those modifications are abstracted for the user modeling the process. The entity used for the assignment of processor is the determination entity, no matter if modified in the current context or not. That is, when a modeler creates the process model (such as, the single workflow steps), in the section for defining the recipients of a user task, the modeler will refer to the abstract determination rule entity, regardless whether the role has been reassigned or not. For example, in the task “Approve Design Proposal,” the role “Designer” is chosen as a recipient. The role “Designer” could also be used in other tasks of the process. If the modeler decides to reassign or refine this role, she will do this in one central place and the reassignment or refinement will affect the whole context without the need for the modeler to change each individual step or task. Correspondingly, the modeler can also easily revert the reassignment or refinement back to the fully system-aided determination for all steps at once. This means the modeler does not chose either a role “Refined Designers” or “System-determination Designers,” instead, the modeler chooses a general pointer to the role “Designer” without specifying if it is refined or not. Thereby, one advantage of the described solution is that the modifications of the determination can be done at any point in time without breaking a workflow step definition. In some implementations, the modification has to be done only once, possibly affecting multiple steps, averting the need to adapt every single occurrence in a step. Further, it is possible to reuse a modified user determination in multiple steps within a workflow definition or workflow instance. At any point in time, the user can decide if the system-aided determination shall be used for all of those steps or a concrete set of users. As such, using the described solution, the current result of the determination by the system can be used as a starting point for modifications, and the modification of the determination is herewith only affective for the current modeling context.

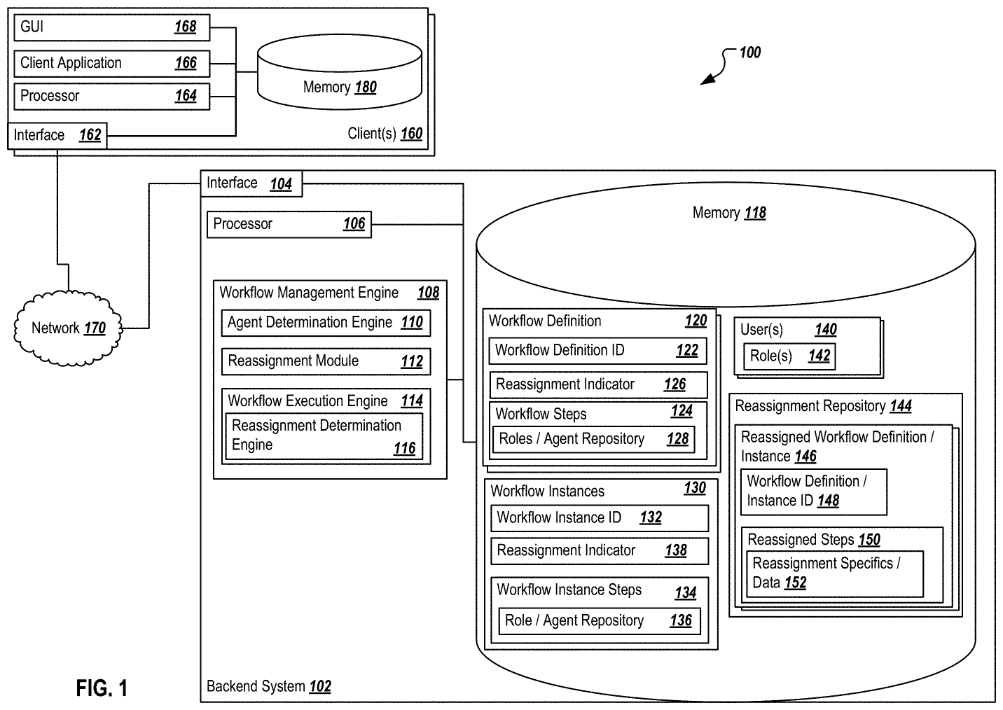

Turning to the illustrated implementation, FIG. 1 is a block diagram illustrating an example system 100 for executing a workflow according to reassigned roles and the users associated with the reassigned role. As illustrated in FIG. 1, system 100 is associated with a backend system 102 for managing workflows that are associated with roles and set of users. The system 100 can allow the illustrated components to share and communicate information across devices and systems (e.g., backend system 102, client(s) 160, among others, using network 170). In some instances, at least some or all of the components may be cloud-based components or solutions, while in other instances, non-cloud systems may be used. In some instances, non-cloud-based systems, such as on premise systems, may use or adapt the processes described herein. Although components are shown individually, in some implementations, functionality of two or more components, systems, or servers may be provided by a single component, system, or server.

As used in the present disclosure, the term “computer” is intended to encompass any suitable processing device. For example, backend system 102 and client(s) 160 may be any computer or processing device such as, for example, a blade server, general-purpose personal computer (PC), Mac®, workstation, UNIX-based workstation, or any other suitable device. Moreover, although FIG. 1 illustrates a single backend system 102, the system 100 can be implemented using a single system or more than those illustrated, as well as computers other than servers, including a server pool. In other words, the present disclosure contemplates computers other than general-purpose computers, as well as computers without conventional operating systems. Similarly, the client(s) 160 may be a system, which can request data and interact with the backend system 102. The client(s) 160, in some instances, may be either a desktop system, a client terminal, or any other suitable device, including a mobile device, such as a smartphone, tablet, smartwatch, or any other mobile computing device. In general, each illustrated component may be adapted to execute any suitable operating system, including Linux, UNIX, Windows, Mac OS®, Java™, Android™, Windows Phone OS, or iOS™, among others.

In general, the backend system 102 may be associated with the execution of one or more workflows and analyses associated with various users and restriction rules that are applied to certain roles or tasks within the workflow. In some instances, the backend system 102 may be associated with or can execute an enterprise application, including but not limited to an enterprise resource planning (ERP) system, a modeling user relationship management (CRM) system, a supplier relationship management (SRM) system, a supply chain management (SCM) system, a product lifecycle management (PLM) system, or any other suitable system. In some instances, backend system 102 may be associated with or can execute a combination or at least some of these systems to provide an end-to-end enterprise application or portions thereof.

As illustrated, the backend system 102 is associated with a plurality of workflow definitions 120 (shown within memory 118). Each workflow definition 120 is associated with a workflow definition ID 122, a plurality of workflow steps 124, and a reassignment indicator 126, where each step of the workflow definition can be a task pointing to a decision or a specific transaction associated with a decision, where a decision might contain specifications about agents and deadline monitoring for a step. In some implementations, the workflow definition 120 can be created in a workflow builder (not shown in FIG. 1,) and a user can include single-step tasks and multiple step tasks into the workflow definition 120 using an integrated workflow explorer (not shown in FIG. 1). In some instances, the workflow definition 120 may be generated just prior to the process as described herein, while in others, the workflow definition 120 may be existing, where the presently described solution is applied to existing definitions 210. Workflow steps 124 can be associated with pre-defined roles or agents repository 128, where each step of the workflow step 124 is associated with at least one role assigned to at least one pre-defined agent, wherein the at least one role and the at least one agent are selected from the pre-defined roles or agents repository 128. The reassignment indicator 126 can be an identifier, a flag, etc., indicating a reassignment occurred to a role or agent assignment associated with the workflow definition or workflow instance. In some implementations, each agent can be associated with one or more business roles, where those business roles define some relationship to or position within the enterprise associated with the backend system 102. If the pre-defined roles or agents associated with a workflow step is changed, for example, the role is reassigned to a set of new agents, and all workflow steps associated with that reassigned role will be affected, so instead of specifying a set of concrete users at each step, the reassignment of the role can be made at a workflow definition or workflow instance level. For example, the role “Design Engineer” was initially assigned to agents A, B, and C (based on the dynamic determination of those agents' role). Under the conventional approach, a modeler who wants to reassign the role “Design Engineer” to agents A, B and D needs go to each step and reassign that role to agents A, B and D in each step. By using the refinement method proposed in this disclosure, however, the modeler can first assign the role “Design Engineer” to all those steps and then refine this role to always contain agents “A, B, and D” for this context.

The roles and agents assigned to a role can be pre-defined by applying a concrete set of users for a specific workflow step. For example, in the purchase order workflow example, for the specific step “going to office 5006 to check if there is a printer,” the system can pre-assign the role “printer checker” to a set of individual agents “A, B, and C”. Alternatively, instead of associating specific roles identifying specific individual agents and tasks that an individual agent is assigned, the workflow definition can assign agents to the workflow based on system-aided determination technologies. Under this approach, the workflow can define task to a particular business role, where the tasks associated with the particular role are then dynamically applied to end users based on restricted roles. In the same example, the step in a workflow definition may be associated with a role “printer checker,” where the workflow definition indicates or defines that agents with the role “printer checker” can be assigned to checking the printer in the organization. The workflow definition also contains restriction rules limiting only agents who have mechanic work experience to be assigned to the “printer checker” role. At intervals or in response to a request to run an agent determination check, the workflow definitions can be run for particular sets of agents based on the defined restriction rules and existing master data identifying that set of agents and their associated roles. Based on that information, a set of individual agents “A, B, and D” can be found as the responsible agents for this role, and the role “printer checker” and the pre-defined agents “A, B, and D” can be stored in the pre-defined roles or agents repository 128.

When a modeling user attempts to assign a task, such as to check the printer at office 5006, the pre-defined roles or agents repository 128 will include an indication that a particular user or a particular group of users are allowed to pursue such a task, and present this particular user or the particular group of users upon request to the backend system 102. If, for some reason, none of the pre-defined agents is available for the work or task, the system may be able to re-execute the restriction rule and identify other possible agents for the work item associated with that step. Further, for some rule-based user determination technologies, the system can also create a set of “substitute agents” in case the re-execution of the rule renders no result. However, for both approaches, reassigning a role requires additional work. For example, in the former approach, where the assignment is based on a concrete set of users for a specific workflow step, to reassign a role a modeling user may need to go to each step containing that role and manually update those steps. In the latter approach, reassigning a role requires a modification to the user determination rules that are based on the user determination technologies.

The memory 118 also contains a plurality of workflow instances 130, which are executable instances of a workflow defined by an associated workflow template, which is the design-time version of the workflow. A workflow can change, for example, for reasons associated with business processes. The change to a workflow can be captured in corresponding changes in the associated workflow template. Therefore, any changes or modifications made to the workflow definition 120 could affect each work instance 130 covered by that work definition. The workflow instances 130 are associated with workflow instance ID 132, each workflow instance 130 associated with a series of workflow instance steps 134 (as defined by the workflow definition 120) from which it has been instantiated or created. Like the workflow definition ID 122, the workflow instance ID 132 is a unique identifier associated with each workflow instance. Each workflow instance step 134 is also associated with pre-defined roles or agents repository 136, where the pre-defined roles or agents repository 136 perform the same function as the pre-defined roles or agents repository 128. The roles and agents in the pre-defined roles or agents repository 136 can be pre-defined the same way as those in the pre-defined roles and agents repository 128. Further, if a role associated with a step from the workflow instance steps 134 is reassigned with a new set of users, that step will be associated with a reassignment indicator 138 on an instance level instead, indicating a reassignment occurred to a role associated with this specific step. Notably, because each workflow definition may cover multiple workflow instances, the change or modification made to any role or agent in the pre-defined roles or agents repository 128 would also affect the relevant role or agent in the pre-defined roles or agent repository 136.

In this example system, a modeling user can reassign one or more roles associated with a workflow definition 120 or workflow instance 130, and the reassigned roles as well as associated agents can be stored in the reassignments repository 144. The reassignments repository 144 can contain or reference the reassigned workflow definition/instance 146, where those reassigned workflows are associated with at least one reassigned role. Each of the reassigned workflow definitions/instances 146 is associated with a workflow definition/instance ID 148, which is a unique identifier of the workflow definition/instance that is associated with at least one reassigned role. The particular reassigned workflow definition/instance 146 may identify particular reassigned steps 150 performed by the at least one reassigned role, and other reassignment specifics/data 152. This data 152 can specify reassignments made to the roles, for example, which role(s) in the pre-defined roles or agents repository 128 and/or 136 is reassigned, and which user(s) 140 or alternative roles 142are to be used for that reassignment.

In generating the reassignments repository 144, the modeling user can prepare or use any suitable method of coding or define the customized reassignments. In some instances, after reassigning the roles, if the results of the reassignment supported by the system-aided technologies, the reassignments repository 144 or portions thereof can be stored in the actual workflow definition 120 or the workflow instance 130, overriding pre-defined role(s) or agent(s) sets in the pre-defined roles or agents repository 128 or 136 (depending on whether the reassignment occurred on a workflow definition or a workflow instance level) as newly defined pre-defined roles or agents. In some instances, that reassignment may override some pre-defined role-agent set if there is a conflict. In these cases, the result of the determination at the moment of the reassignment can be used as a starting point for modifications to future steps. Those modifications, however, may be limited to the particular workflow definition or workflow instance associated with the reassignment, and may affect neither other workflow definitions or workflow instances nor the determination technology, other than additional workflow instances 130 derived or instantiated from a modified workflow definition 120. In those instances, future instantiations may inherit the modifications defined for the underlying workflow definition 120.

In some instances, the reassignments repository 144 could be stored remotely or separately and linked to the workflow definition 120 or the workflow instance 130 corresponding to the reassignment using the associated workflow definition/instance ID 148. In doing so, the particular reassignment in the reassignments repository 144 can be associated with a workflow definition/instance ID 148 that identifies or otherwise links to a plurality of dynamically determined roles and set of users selecting from user(s) 140 and role(s) 142. Therefore, when the system executes a specific workflow step that is associated with workflow definition 120 or workflow instance 130, a determination that a reassignment indicator is associated with that step can be used by the system to execute that step according to the corresponding reassigned role-agent setting, instead of the pre-defined role-agent setting associated with that specific step. To do so, the system can identify the workflow definition ID 122 or the workflow instance ID 132 associated with the reassignment and then search for a reassignment in the reassignments repository 144 based on the matching workflow definition/instance ID 148. Once a matching reassignment workflow definition/instance 146 is found in the repository 144, the system can check the reassignment specifics/data 152 associated with that reassignment, and execute the workflow step according to the reassigned role-agent setting indicated by the reassignment specifics/data 152.

The reassignments repository 144 can be connected to the workflow management engine 108, so that the system (e.g., the agent determination engine 110 using the reassignment module 112) can access the corresponding reassignments repository 144 defining the reassigned step 150 and reassignment specifics/data 152 to generate one or more determinations based on the reassignments. The agent determination engine 110 can determine which agents (or users 140) are assigned to which role(s) 142 based on the system-aided determination technologies and save the results in the pre-defined roles or agents repository 128 and 136.

The reassignment module 112 of the workflow management engine 108 may be triggered or used when a reassignment is initiated by a modeling user at a frontend UI associated with the workflow management engine 108 (presented via GUI 168 at a client 160). In response to the modeling user completing the reassignment via the UI, the reassignment module 112 can identify the selections from the UI and associate the reassigned role(s) with the corresponding set of users or alternative role(s) identified during the reassignment. The results of the reassignment can then be saved at or in the reassignments repository 144. If the result of the reassignment supported by the determination technology, the result can be used as a starting point for further modification. For example, the SAP S/4 Responsibility Management provides an API through which the modeler can execute the rule and get the resulting users at any time. In such case, the resulting users can be displayed as a starting point for further modification.

In general, memory 118 may represent a single memory or multiple memories. The memory 118 may include any memory or database module and may take the form of volatile or non-volatile memory including, without limitation, magnetic media, optical media, random access memory (RAM), read-only memory (ROM), removable media, or any other suitable local or remote memory component. The memory 118 may store various objects or data, such as, information on one more users 140, workflow definitions 120, workflow instances 130, the reassignments repository 144, as well as others, including financial data, user information, administrative settings, password information, caches, applications, backup data, repositories storing business and/or dynamic information, and any other appropriate information associated with the backend system 102, including any parameters, variables, algorithms, instructions, rules, constraints, or references thereto. Additionally, the memory 118 may store any other appropriate data, such as VPN applications, firmware logs and policies, firewall policies, a security or access log, print or other reporting files, as well as others. While illustrated within the backend system 102, some or all of memory 118 may be located remote from the backend system 102 in some instances, including as a cloud application or repository, or as a separate cloud application or repository when the backend system 102 itself is a cloud-based system. In some implementations, the reassignment repository 144 can be included in the workflow definition or workflow instance itself. In some instances, particularly in enterprise systems, the reassignments repository 144 may be stored in a centralized repository to allow access to various applications and components in an end-to-end system. Similarly, the reassignments repository 144 may be stored separately, as a separate storage component in some instances. With that said, the backend system 102 and its operations may be able to access relevant data using internal connections and/or through connections to network 170, where appropriate.

Returning generally to the backend system 102, the backend system 102 includes an interface 104, processor 106, workflow management engine 108, and memory 118. The interface 104 is used by the backend system 102 for communicating with other systems and components in a distributed environment—including within the environment 100—connected to the network 170, e.g., one or more clients 160, as well as other systems communicably coupled to the illustrated backend system 102 and/or network 170. Generally, the interface 104 comprises logic encoded in software and/or hardware in a suitable combination and operable to communicate with the network 170 and other components. More specifically, the interface 104 may comprise software supporting one or more communication protocols associated with communications such that the network 170 and/or the interface's hardware is operable to communicate physical signals within and outside of the illustrated environment 100. Still further, the interface 104 may allow the backend system 102 to communicate with one or more clients 160, regarding particular backend-related operations, as described in the present disclosure.

Network 170 facilitates wireless or wireline communications between the components of the environment 100 (e.g., between the backend system 102 and a particular client 160), as well as with any other local or remote computer, such as additional mobile devices, clients (e.g., clients 160), servers, databases, or other devices or components communicably coupled to network 170, including those not illustrated in FIG. 1. In the illustrated environment, the network 170 is depicted as a single network, but may be comprised of more than one network without departing from the scope of this disclosure, so long as at least a portion of the network 170 may facilitate communications between senders and recipients. In some instances, one or more of the illustrated components (e.g., the backend system 102) may be included within network 170 as one or more cloud-based services or operations. The network 170 may be all or a portion of an enterprise or secured network, while in other instances, at least a portion of the network 170 may represent a connection to the Internet. In some instances, a portion of the network 170 may be a virtual private network (VPN). Further, all or a portion of the network 170 may comprise either a wireline or wireless link. Example wireless links may include 802.11a/b/g/n/ac, 802.20, WiMax, LTE, and/or any other appropriate wireless links. In other words, the network 170 encompasses any internal or external network, networks, sub-network, or combination thereof operable to facilitate communications between various computing components inside and outside the illustrated environment 100. The network 170 may communicate, for example, Internet Protocol (IP) packets, Frame Relay frames, Asynchronous Transfer Mode (ATM) cells, voice, video, data, and other suitable information between network addresses. The network 170 may also include one or more local area networks (LANs), radio access networks (RANs), metropolitan area networks (MANs), wide area networks (WANs), all or a portion of the Internet, and/or any other communication system or systems at one or more locations.

The backend system 102 also includes one or more processors 106. Although illustrated as a single processor 106 in FIG. 1, multiple processors may be used according to particular needs, desires, or particular implementations of the environment 100. Each processor 106 may be a central processing unit (CPU), an application specific integrated circuit (ASIC), a field-programmable gate array (FPGA), or another suitable component. Generally, the processor 106 executes instructions and manipulates data to perform the operations of the backend system 102, in particular those related to the workflow management engine 108. Specifically, the processor(s) 106 executes the algorithms and operations described in the illustrated figures, as well as the various software modules and functionality, including the functionality for sending communications to and receiving transmissions from clients 160, as well as to other devices and systems. Each processor 106 may have a single or multiple core, with each core available to host and execute an individual processing thread.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, JavaScript, Java™, Visual Basic, assembler, Peri®, any suitable version of 4GL, as well as others.

In general, the backend system 102 may be associated with the execution of one or more reassignments operations and functionality, including the workflow management engine 108. The workflow management engine 108 manages the workflow, and it can perform various operations and activities associated with the creation and assignment of various roles. As illustrated, the workflow management engine 108 includes the agent determination engine 110, the reassignment module 112, and the workflow execution engine 114. The agent determination engine 110 can be used to determine which agents to assign to the one or more roles within the workflow when the workflow management engine executes the workflow. The agent determination engine 110 can also be used by administrators and key users to define or modify one or more business roles. As described above, roles are not specific to a single agent, but represent a common role performed by a plurality of end users. Example roles may include “Manager”, “Technician”, and “Key User”, among others. As particular roles are defined, one or more particular users 140 can be associated with particular roles 142 to allow groups of users to be dynamically assigned rights as opposed to manually assigning individuals such authorizations. Once particular users 140 are assigned to particular roles 142 using the agent determination engine 110, the business role as well as its associated agents can be stored for future applications.

The periodic or triggered operation performed by workflow execution engine 114 can identify particular agents associated with a business role and perform the operations to dynamically determine, based on the particular end user, their assigned business role(s), and their specific associations as defined by the workflow definition 120 associated with the assigned business role, the corresponding set of pre-defined roles or agents repository 128 associated with each end user. The operations of the workflow execution engine 114 can be triggered in response to any particular event, periodically based on a predetermined timeline or on a schedule, or in response to particular detected events. As the workflow execution engine 114 executes the steps of workflow at the runtime, the reassignment determination engine 116 can perform reassignments to role(s) associated with a step within that workflow. The reassignment process can be independent of the process of executing the workflow, and can be used without breaking or otherwise interrupting the workflow process. In some instances, particular workflows may be modified while a process is executing. The updates can affect future workflow tasks, such that a change to a task that is not yet executed may be realized during the next execution without leaving or restarting the workflow process.

As illustrated and described, one or more clients 160 may be present in the example system 100. In some instances, a different number of clients 160 may be associated with different types of users. For example, client 160 may be associated with a key user or administrator, or some other user associated with the creation of reassignments repository 144 for modeling user-defined roles, or with users authorized to interact with one or more business roles, workflow definition 120 assignment to those business roles, or other administrative tasks or operations. In some instances, clients 160 may be associated with end users interacting with a particular application and receiving responsive information sets in response to queries and requests to the workflow execution engine 114, sent using client application 166.

Each client 160 may be associated with requests transmitted to the backend system 102 related to the client application 166, executing on or at the client 160. As illustrated, the client 160 may include an interface 162 for communication (similar to or different from interface 104), a processor 164 (similar to or different from processor 106), the client application 166, memory 180 (similar to or different from memory 118), and a graphical user interface (GUI) 168.

The illustrated clients 160 are intended to encompass any computing device such as a desktop computer, laptop/notebook computer, mobile device, smartphone, personal data assistant (PDA), tablet computing device, one or more processors within these devices, or any other suitable processing device. In general, the clients 160 and their components may be adapted to execute any operating system, including Linux, UNIX, Windows, Mac OS®, Java™, Android™, or iOS. In some instances, the clients 160 may comprise a computer that includes an input device, such as a keypad, touch screen, or other device(s) that can interact with the client application 166, and an output device that conveys information associated with the operation of the applications and their application windows to the user of the clients 160. Such information may include digital data, visual information, or a GUI 168, as shown with respect to the client 160. Specifically, the client 160 may be any computing device operable to communicate queries or communications to the backend system 102, other clients 160, and/or other components via network 170, as well as with the network 170 itself, using a wireline or wireless connection. In general, clients 160 each comprise an electronic computer device operable to receive, transmit, process, and store any appropriate data associated with the environment 100 of FIG. 1. In some instances, different clients 160 may be the same or different types or classes of computing devices. For example, at least one of clients 160 may be associated with a mobile device (e.g., a tablet), while at least one of the clients 160 may be associated with a desktop or laptop computing system. Any combination of device types may be used, where appropriate.

Client application 166 may be any suitable application, program, mobile app, or other components. As illustrated, the client application 166 interacts with the backend system 102 to perform client-side operations associated with a particular backend system 102 and its components (e.g., the workflow management engine 108) via network 170. In some instances, the client application 166 may be a browser, where the functionality of the client application 166 may be realized using a web application or website the user can interact with via the client application 166. In other instances, the client application 166 may be a remote agent, component, or client-side version of the backend system 102 and/or the application. In some instances, the client applications 166 may interact directly with the backend system 102.

GUI 168 of clients 160 can interface with at least a portion of the environment 100 for any suitable purpose, including generating a visual representation of the client applications 166 and/or the content associated with the client applications 166, or other operations of the backend system 102. In particular, the GUIs 168 may be used to present screens or UIs associated with the client applications 166, or backend systems 102. The GUIs 168 may also be used to view and interact with various Web pages, applications, and Web services located local or external to the clients 160. Generally, the GUIs 168 provide the users with an efficient and user-friendly presentation of data provided by or communicated within the system. The GUIs 168 may comprise a plurality of customizable frames or views having interactive fields, pull-down lists, and buttons operated by the user. For example, the GUIs 168 may provide interactive elements that allow a user to view or interact with information related to the operations of processes associated with the backend system 102, including the presentation of and interaction with particular application data associated with the client applications 166, among others. In general, the GUIs 168 are often configurable, support a combination of tables and graphs (bar, line, pie, status dials, etc.), and are able to build real-time portals, application windows, and presentations. Therefore, GUIs 168 contemplate any suitable graphical user interface, such as a combination of a generic web browser, a web-enable application, intelligent engine, and command line interface (CLI) that processes information in the platform and efficiently presents the results to the user visually.

While portions of the elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

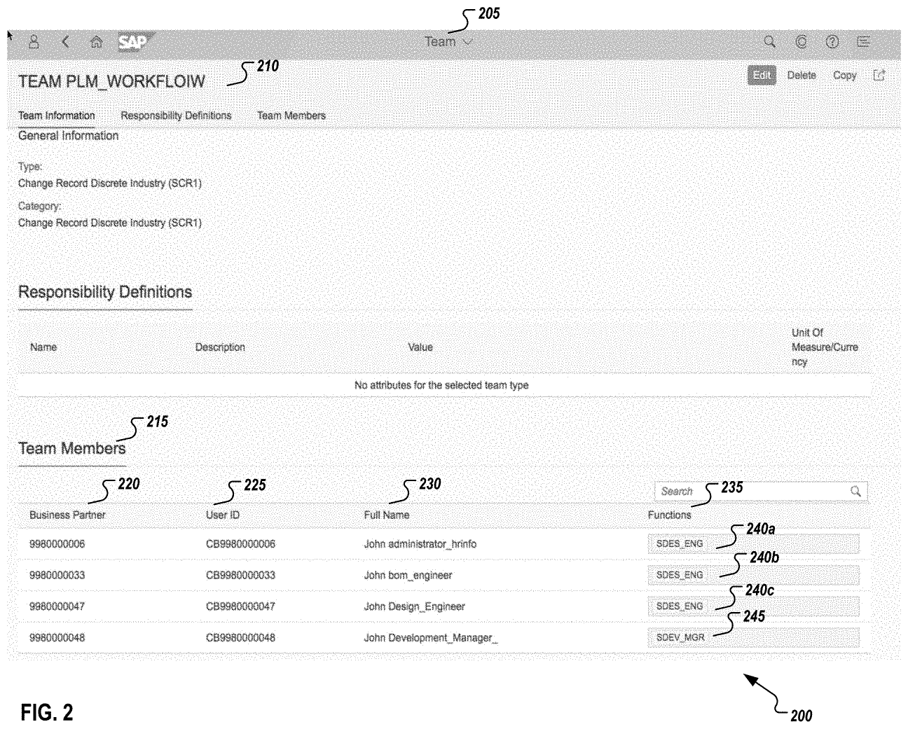

FIG. 2 represents an example screenshot of a user interface 200 illustrating team member responsibility management defined by a user determination technology as applied to the illustrated workflow. The agent determination rules can be maintained by using a responsibility rule, which shows an abstract relationship, for example, the user ID of the person assigned to a position that is assigned to the criteria. The agent determination technology is a technique used by the system to render agents for a task based on a set of rules. For example, a modeling user want to send the work item to all users that have a certain authorization role. They can set the role as a “restricting entity” at the task level, so only the users who have the role are the possible agents for the task. Rule resolution (also known as role resolution) enables a modeling user to assign work to the agents by enabling a modeling user to calculate the responsible agent for a particular work item, which may be based on runtime criteria. For instance, a system may contain a rule that calculates the manager of an employee. At runtime, if the system passes the rule as an employee ID, the rule resolves that particular employee's manager. Responsibility rules may be relatively simple to create and maintain. Various commercial available user determination technologies can be applied, for example, the SAP Business Workflow Agent Rules, and/or SAP S/4 HANA Responsibility Management.

A modeling user can perform various operations related to particular roles. In the illustration of FIG. 2, a TEAM PLM_WORKFLOW tab 205 is presented on the user interface 200. In this industry, PLM (Product lifecycle management) is the process of managing the entire life circle of a product from inception, through engineer design and manufacture, to service and disposal of manufactured product. In this example, the system is used to centrally manage the master data for business partners, modeling users, and vendors. A modeling user can manage users (e.g., teams or team members) associated with certain functions and/or using a responsibility management solution or tool. These users can then be mapped as responsible for a particular activity type in a process step of a workflow scenario. When the Team Information tab 205 is selected, a set of team members 215 for a centrally managed team associated with the particular workflow are presented. Each of the team members 215 is associated with a Business Partner 220, a User ID 225, a Full Name 230, and a Function 235. Every agent may have a user ID 225 which identifies the users.

Function 235 represents roles each team member is associated with, either specifically in this workflow or generally as an assigned role. As illustrated, a list of functions 235, including four roles, are assigned for each corresponding team member. The first three roles, “SDES_ENG” 240 represent pre-defined roles provided by the software vendors for users “John administrator_hrinfo”, “John_bom_enginer”, and “John Design_Engineer” are all “Software Design Engineer.” The last role “SDEV_MGR” 245 represents the system-defined role for “John Development_Manager” as “Software Development manager.” In the illustrated example, all four users have been associated with a particular business role, with three of them available for the same role. Each of these team members assumes responsibility for processing the work item of the workflow.

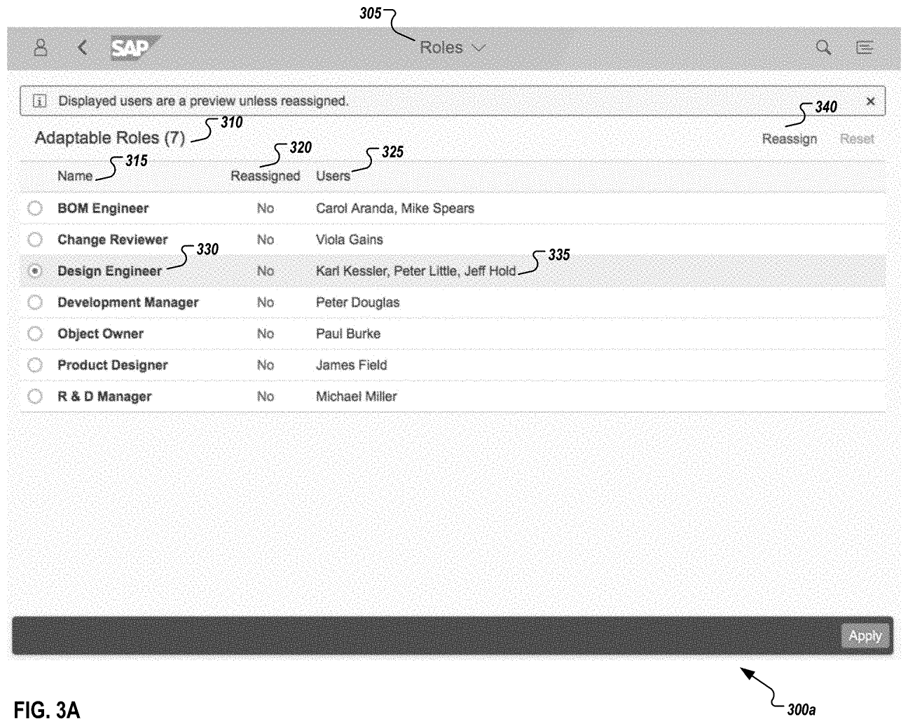

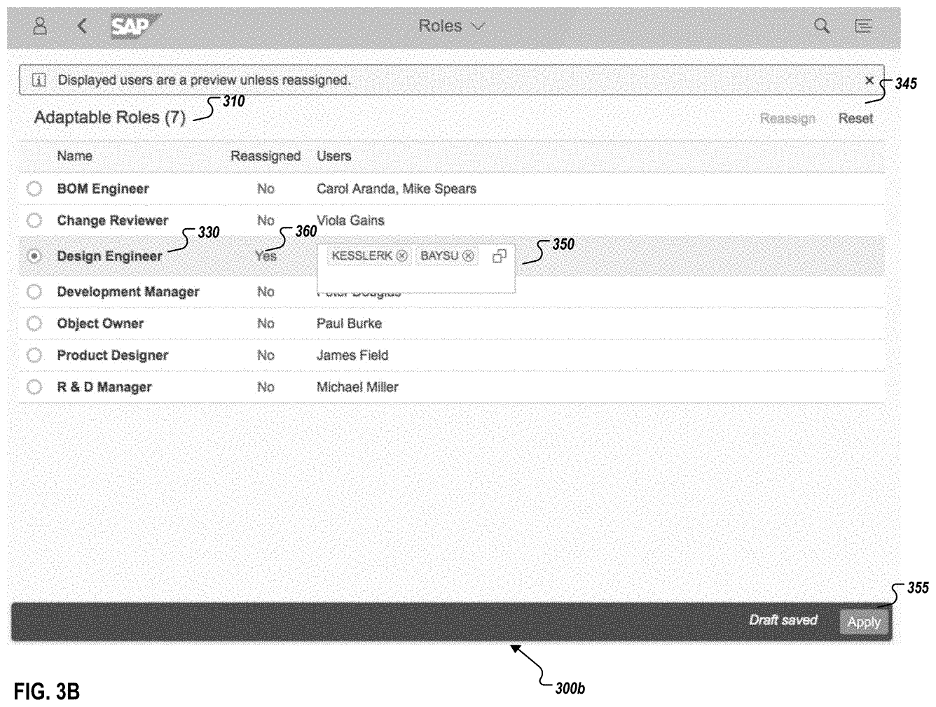

FIG. 3A is an example screenshot of a user interface 300a illustrating a set of available roles and the users dynamically associated with those roles in an adaptable or editable user interface. As described below, the modeling user can select a particular role to reassign using the user interface 300. Specifically, a list of available and adaptable roles 310 can be displayed once the tab of role 305 is selected. Each displayed role 310 is associated with a role name 315, reassignment state 320, and a set of users 325 dynamically determined to be assigned to or associated with the role. The users may initially be assigned to each role based on the system-aided user determination technologies.

In some instances, many agents can be assigned to a single work item, such as when multiple agents are associated with the same role, and wherein the task is specifically associated with a role, not a particular user. As soon as one of the assigned agents processes or executes the particular task, the work item is no longer needed. In some instances, only a single user may be associated with a particular role. In those instances, the person assigned to the role will be the person assigned to a particular task, where the task is assigned to a particular role. In instances where multiple users are associated with a role, the task may provide a notification to each of the users, and the first to respond and perform (or start to perform) the task may be assigned the work, while in others, the task may be performed by a combination of the users. As illustrated, the role “Design Engineer” 330 has been assigned to multiple users 335 “Karl Kessler”, “Peter Little”, and “Jeff Hold” as determined by the system. In the illustrated implementation, a modeling user can reassign one or more roles 310 from the list by clicking the “Reassign” button 340 provided in the right top corner of the user interface 300.

FIG. 3B is an example screenshot illustrating a user interface 300b after a modeling user has decided to refine or reassign a particular role 310. For example, the modeling user can explicitly decide to override a dynamic system-aided determination with a concrete set of users, or can add or delete users from the dynamically determined user group. In some instances, a particular user may be added or deleted from the set of users associated with a particular role 310, while in others, a particular alternative or additional role as defined in the system may be applied. For example, the Design Engineer users may be refined to include one or more Development Managers, in some instances, such that users assigned the role of Development Manager may also be included in the users associated with the Design Engineer role. In some instances, instead of adding or deleting particular users, the process can be used to identify, at a time of checking, the current set of users associated with a particular role. Once the determination is made, the current set of users can be hardcoded, locked into, or otherwise explicitly identified as the particular role. By doing so, the current set of users will be used in future executions instead of using a dynamic determination during execution.

For the modeling user, a visible indication of which of the available roles are currently reassigned may be provided. The UI 300b may also include a Reset button 345, allowing the modeling user to reset the particular role 310 back to the results of the system-aided determination, clearing any prior modifications. As illustrated in FIG. 3B, the modeling user can click or select the control (i.e., the radio button) next to the “Design Engineer” role 330, causing a pop-window 350 or other text box to be presented and made editable. In window 350, the current set of users associated with the role may be included, as well as controls or other interactive elements allowing those users to be removed from the user set. The modeling user can then modify (e.g., by adding or deleting users assigned to the role) the Design Engineer role 330 as desired. In this example, the modeling user removed the system assigned users “Peter Little” and “Jeff Hold,” while adding a new user “Susan Bay” (presented as “BAYSU”, which may refer to the internal system name of the user) to the set of users associated with the Design Engineer role 330. Once changes have been made, such changes can be stored by selecting the apply button 355, activating the reassignment and causing the newly identified set of users to be associated with the Design Engineer role 330 in the present workflow. The reassignment state 360 of the Design Engineer role 330 column can then be changed to “Yes”, clearly denoting the modification. The state 360 can be changed automatically by the system in response to receiving a reassignment. If the reassignment is reset, then the state 360 will be changed back to “No.” The reassignment can hold true for all future executions in the workflow assigned to that particular role.

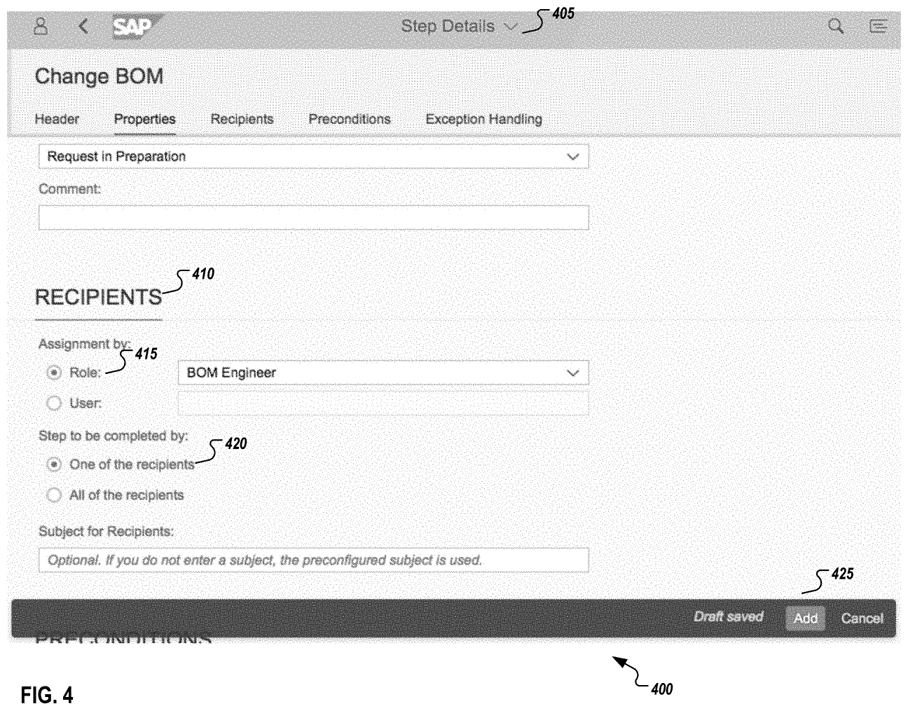

FIG. 4 is an example screenshot illustrating a user interface 400 for adding, editing, and displaying a single workflow step. Notably, in the screen for adding, editing, and displaying a single workflow step, the modeling user works with the determination entity, whether refined or not. The screenshot shows a modeling environment with an excerpt of the properties available when defining a workflow step, and how the reassignment of the role can be done at a workflow definition/instances level without effecting the step definitions. Recipients are selected agents who actually receive work items in their workflow inbox. Bill of Material (BOM) is a complete list of components that make up a finished manufactured product. As illustrated by FIG. 4, once the tab of step details 405 is selected, the recipients 410 in this particular step is specified by assignment of role 415, where the role is for “BOM Engineer.” The modeling user selected this step to be completed by “one of the recipient” 420. By clicking the button “Add” 425 at the right bottom corner of the user interface, the changed recipients will be added to the step of the workflow it within.

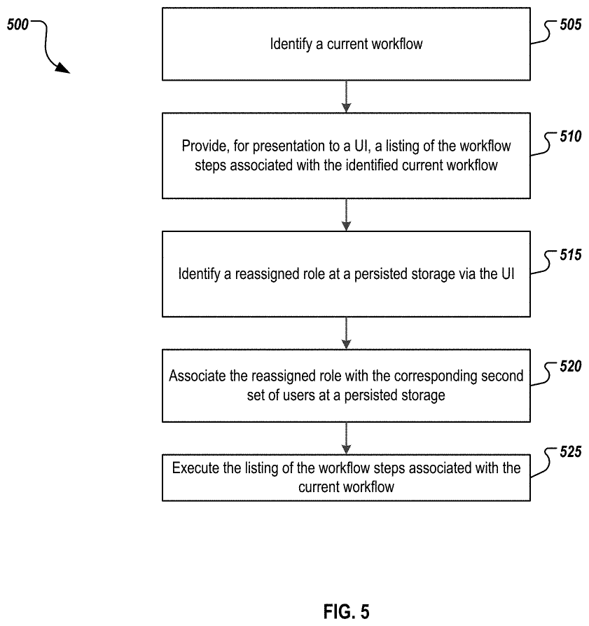

FIG. 5 represents an example flowchart for reassigning a role of a workflow in one implementation. For clarity of presentation, the description that follows generally describes method 500 in the context of the system 100 illustrated in FIG. 1. However, it will be understood that method 500 may be performed, for example, by any other suitable system, environment, software, and hardware, or a combination of systems, environments, software, and hardware as appropriate.

At 505, a current workflow is identified, where the current workflow is associated with at least one workflow step, and where each workflow step is associated with at least one role and a set of users assigned to the role. In some implementations, the workflow may comprise a workflow instance, where the workflow instance is instantiated from an underlying workflow definition. The reassignment to the workflow instance may be applied only to the current workflow instance in such implementations, and the reassignment may not be propagated to other workflow instances instantiated from the workflow definition. In some implementations, the workflow may be a workflow definition from which a plurality of workflow instances can be instantiated. When the reassignment is applied to the workflow definition, each workflow instance instantiated from the workflow definition may be modified.

At 510, a listing of the workflow steps associated with the identified current workflow is provided for presentation to a user interface (UI), where at least one role is associated with each workflow step, and wherein each role is assigned a first set of users.

At 515, a reassigned role is identified via the UI, where the reassigned role is associated with at least one workflow step from the listing of the workflow steps. In some instances, the reassigned role may have already been used in an earlier step. In such instances, the reassigned role will be applied to steps that have not yet been performed. In other words, changes to a particular workflow instance or scenario will be applied to uncompleted steps. As such, changes to a particular workflow may only be reflected after the reassignment. If multiple parties execute a particular scenario or instance, different operations and assignments may be used in otherwise identical or related workflows, as the change may have occurred after at least some steps were executed prior to the reassignment. The reassigned role can be reassigned by assigning a second set of users to the role to replace the first set of users that is associated with the role. In some implementations, assigning a second set of users to the role to replace the first set of users associated with the role may include adding or deleting at least one user from the first set of users to create the second set of users. For example, one or more users may be removed from the first set to create the second set, and/or one or more new users may be added to the list of users. In some instances, the second set of users may be associated with a particular role, and can be dynamically determined when the reassignment is defined by a particular role. In some instances, the reassigned role may be a role that has not yet been used in any step of the workflow, and the same reassignment approach will also be applied to such scenario, where the modeler can assign a set of agents to this “new” role at a workflow instance or workflow definition level to affect all the future steps may use this role. The details will not be discussed in this disclosure.

At 520, the reassigned role is associated with the corresponding second set of users at a persisted storage, which may be made available in future executions of the particular workflow. In some instances, particular steps/tasks may be associated with a reassignment indicator, while in others, a table or other data structure may be created and/or updated to reflect the reassignment. In those instances, the reassignment indicator and/or data structure may be considered at execution time to determine whether one or more reassignments of particular steps are to be applied.

At 525, the listing of the workflow steps associated with the current workflow is executed. In some implementations, to execute the listing of the workflow steps associated with the current workflow, first each workflow step from the listing of workflow step is identified. Then a determination is made as to whether the role associated with the workflow step is a reassigned role based on a reassignment indicator persisted in memory associated with the role. In response to the determination that the role is not associated with a reassignment indicator, the workflow step is executed using the first set of users associated with the role. In response to the determination that the role is associated with a reassignment indicator, a second set of uses defined in the memory is identified as a reassigned set of users, and the workflow step is executed using the second set of users.

In some implementations, executing the workflow step according to a role and the second set of users associated with the role may further include identifying a workflow ID associated with the current workflow. A reassignment repository is then accessed at the persistent storage. The assignment repository can comprise a plurality of reassignments, and each of the reassignment is associated with a workflow ID that corresponds to a workflow associated with the reassignment. Each reassignment is associated with a reassign role, and the reassigned role is associated with a second set of users. In response to assessing the reassignment repository, a reassignment is selected, and the selected reassignment is associated with a workflow ID that is the same as the workflow ID of the current workflow. In response to the selection of the reassignment, the workflow step is executed according to the role and the second set of users that are associated with the selected reassignment.

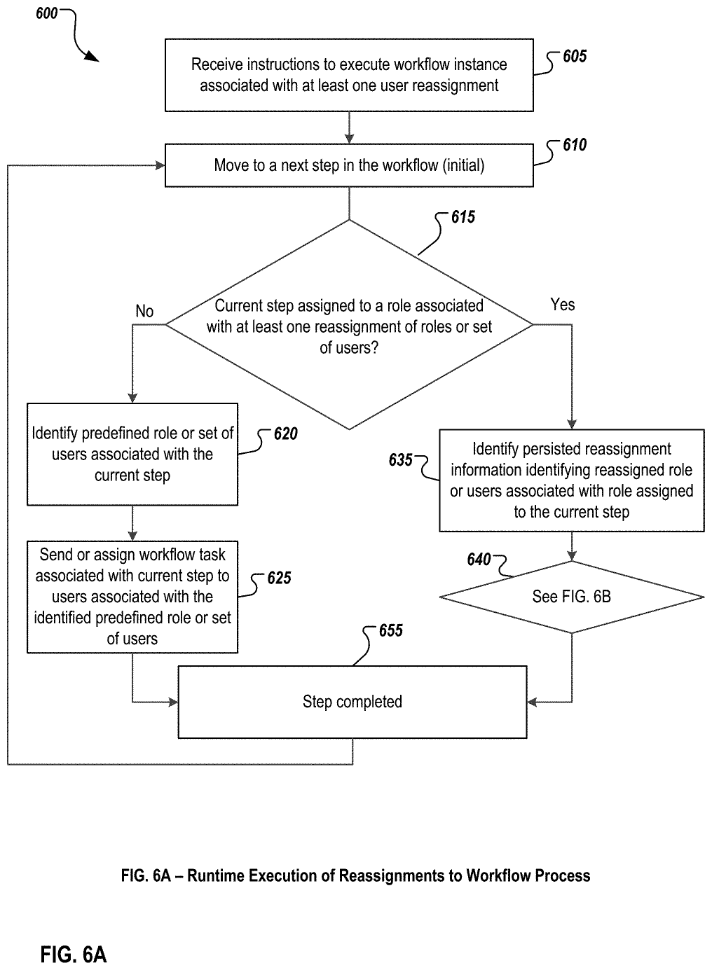

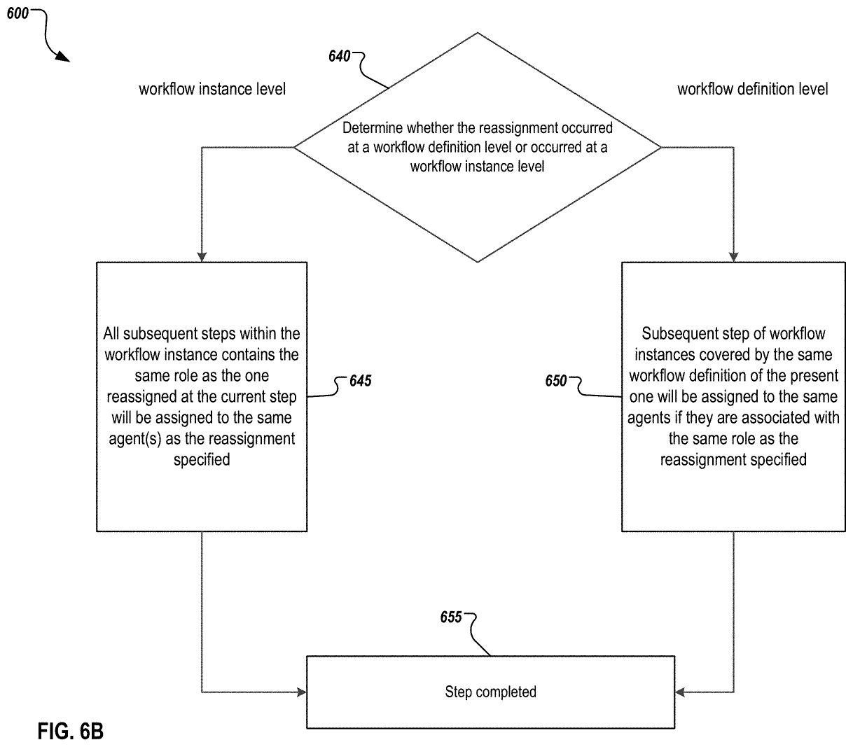

FIG. 6 represents an example flow illustrating a method 600 for executing a workflow with reassigned roles. For clarity of presentation, the description that follows generally describes method 600 in the context of the system 100 illustrated in FIG. 1. However, it will be understood that method 600 may be performed, for example, by any other suitable system, environment, software, and hardware, or a combination of systems, environments, software, and hardware as appropriate.

At 605, instructions to execute a workflow associated with at least one user reassignment is received. The instruction can be sent by a modeling user, or can be sent in the form of a triggering event. The step associated to a workflow definition, or a workflow instance. In some instances, a UI similar to the UI provided in FIG. 1 may be provided. At 610, the process moves to a next step in the workflow.

At 615, a determination is made as to whether the current step assigned to a role is associated with at least one reassignment of roles or set of users. In some implementations, such as that of FIG. 1, for example, a reassignment module 112 can attempt to match a workflow definition/instance ID of the executing workflow definition/instance to one or more of the workflow definition/instance IDs associated with one or more reassignments that may be stored in the reassignment repository. If no match is found, then no reassignment may be associated with the current workflow, and the current step(s) will be executed based on the pre-defined roles. At 620, the roles, the pre-defined role or sets of users are associated with the current step, are identified. In response to the identified roles or set of users, workflow task associated with current step is sent or assigned to users associated with the identified pre-defined role or set of users.

Returning to 615, in response to a match being found, method 600 continues at 635, as the determination may identify that the current step is associated with at least one reassignment of roles or set of users. At 635, the persisted reassignment information identifying the reassigned role or users associated with role assigned to the current step is identified. At 640, in response to the identification of the persisted reassignment information identifying the reassigned role or users associated with role assigned to the current step, it is determined whether the reassignment occurred at a workflow definition level or occurred at a workflow instance level. The determination may be made, in some instances, decision can be made by identifying the workflow definition/instance ID of the workflow definition/instance associated with the assignment.

In response to a determination that the reassignment was made at or is associated with a workflow instance level, method 600 continues to 645 (shown in FIG. 6B). At 645, in response to a reassignment of role occurred at a workflow instance level, workflow tasks associated with current step are sent or assigned to users associated with the reassigned role or users based on the identified reassignment information. That is, all subsequent steps within the workflow instance associated with the same role as the role reassigned at the current step will be assigned to the same agent(s) as the reassignment specified.

Returning to 640, in response to a determination that a reassignment occurred or was defined at the workflow definition level, method 600 continues to 650. At 650 (shown in FIG. 6B), workflow instances containing the workflow tasks associated with current step are assigned to users associated with the reassign role or users based on the identified reassignment information. That is, subsequent steps of workflow instances instantiated from the same workflow definition associated with the reassignment of the present one can be assigned to the same agents if they are assigned to the same role as the particular reassignment.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware or software (or a combination of hardware and software), may interface with each other or the interface using an API or a service layer (or a combination of API and service layer). The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other suitable language providing data in XML format or other suitable format. The API or service layer (or a combination of the API and the service layer) may be an integral or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described earlier as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described earlier should not be understood as requiring such separation or integration in all implementations, and it should be understood that the described program components and systems can generally be integrated together in a single software product or packaged into multiple software products.

Accordingly, the earlier description of example implementations do not define or constrain this disclosure. Other changes, substitutions, and alterations are also possible without departing from the spirit and scope of this disclosure.

Furthermore, any claimed implementation described later is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
executing, at runtime, a plurality of operations defined in a listing of workflow steps associated with a current workflow, wherein each step is associated with a role associated with the execution of the step, and wherein executing the plurality of operations comprises:
identifying a workflow step from the listing of workflow steps;
determining whether the role associated with the workflow step is a reassigned role based on an reassignment indicator persisted in a memory associated with the role;
in response to the role not being associated with a reassignment indicator, executing the workflow step using a first set of users associated with the role; and
in response to the role being associated with a reassignment indicator, identifying a second set of users defined in the memory as a reassigned set of users and executing the workflow step using the second set of users;
wherein, at design time, at least one role is reassigned by:
identifying a current workflow, wherein the current workflow associated with at least one workflow step, and wherein each workflow step associated with at least one role and a set of users assigned to the role;
providing for presentation to a user interface (UI), a listing of the workflow steps associated with the identified current workflow, wherein at least one role is associated with each workflow step, and wherein each role is assigned a first set of users;
identifying, via the UI, a reassigned role, wherein the reassigned role is associated with at least one workflow step from the listing of the workflow steps, and wherein the reassigned role is reassigned by assigning a second set of users to the role to replace the first set of users that is associated with the role; and
associating, at a persisted storage, the reassigned role with the corresponding second set of users.

2. The method of claim 1, wherein the assigning a second set of users to the role to replace the first set of users that is associated with the role comprises adding or deleting at least one user from the first set of users.

3. The method of claim 1, wherein the assigning a second set of users to the role to replace the first set of users that is associated with the role comprises explicitly identifying the first set of users as the second set of users.

4. The method of claim 1, wherein the workflow comprises a workflow instance, the workflow instance instantiated from a workflow definition, wherein the reassignment to the workflow instance applies only to the current workflow instance and the reassignment is not propagated to other workflow instances instantiated from the workflow definition.

5. The method of claim 1, wherein the workflow comprises a workflow definition from which a plurality of workflow instances can be instantiated, and wherein the reassignment is applied to each of the plurality of workflow instances instantiated from the workflow definition.

6. The method of claim 1, wherein executing the listing of the workflow steps associated with the current workflow comprises:
identifying each workflow step from the listing of workflow steps;
executing the workflow step according to a role and the first set of users associated with the role, wherein the role is associated with the workflow step, and wherein the role is not a reassigned role; and
executing the workflow step according to a role and the second set of users associated with the role, wherein the role is associated with the workflow step, and wherein the role is a reassigned role.

7. The method of claim 6, wherein the reassigned role is associated with a reassignment indicator.

8. The method of claim 6, wherein executing the workflow step according to a role and the second set of users associated with the role, comprises:
identifying a workflow ID associated with the current workflow;
accessing, at the persisted storage, a reassignment repository, wherein the reassignment repository comprises a plurality of reassignments, wherein each reassignment associated with a workflow ID corresponding to a workflow with which the reassignment is associated, wherein each reassignment is associated with a reassigned role; and wherein the reassigned role is associated with a second set of users;
selecting, the reassignment associated with the same workflow ID as the workflow ID associated with the current workflow; and
executing the workflow step according to the role and the second set of users associated with the selected reassignment.

9. A system, comprising:
at least one hardware processor; and
a memory communicatively coupled to the at least one processor, the memory storing instructions which, when executed, cause the at least one processor to perform operations comprising:
executing, at runtime, a plurality of operations defined in a listing of workflow steps associated with a current workflow, wherein each step is associated with a role associated with the execution of the step, and wherein executing the plurality of operations comprises:
identifying a workflow step from the listing of workflow steps;
determining whether the role associated with the workflow step is a reassigned role based on an reassignment indicator persisted in a memory associated with the role;
in response to the role not being associated with a reassignment indicator, executing the workflow step using a first set of users associated with the role; and
in response to the role being associated with a reassignment indicator, identifying a second set of users defined in the memory as a reassigned set of users and executing the workflow step using the second set of users;
wherein, at design time, at least one role is reassigned by:
identifying a current workflow, wherein the current workflow associated with at least one workflow step, and wherein each workflow step associated with at least one role and a set of users assigned to the role;
providing for presentation to a user interface (UI), a listing of the workflow steps associated with the identified current workflow, wherein at least one role is associated with each workflow step, and wherein each role is assigned a first set of users;
identifying, via the UI, a reassigned role, wherein the reassigned role is associated with at least one workflow step from the listing of the workflow steps, and wherein the reassigned role is reassigned by assigning a second set of users to the role to replace the first set of users that is associated with the role; and
associating, at a persisted storage, the reassigned role with the corresponding second set of users.

10. The computer-implemented system of claim 9, wherein the assigning a second set of users to the role to replace the first set of users that is associated with the role comprises adding or deleting at least one user from the first set of users.

11. The computer-implemented system of claim 9, wherein the assigning a second set of users to the role to replace the first set of users that is associated with the role comprises explicitly identifying the first set of users as the second set of users.

12. The computer-implemented system of claim 9, wherein the workflow comprises a workflow instance, the workflow instance instantiated from a workflow definition, wherein the reassignment to the workflow instance applies only to the current workflow instance and the reassignment is not propagated to other workflow instances instantiated from the workflow definition.

13. The computer-implemented system of claim 9, wherein the workflow comprises a workflow definition from which a plurality of workflow instances can be instantiated, and wherein the reassignment is applied to each of the plurality of workflow instances instantiated from the workflow definition.

14. The computer-implemented system of claim 9, wherein executing the listing of the workflow steps associated with the current workflow comprises:
identifying each workflow step from the listing of workflow steps;
executing the workflow step according to a role and the first set of users associated with the role, wherein the role is associated with the workflow step, and wherein the role is not a reassigned role; and
executing the workflow step according to a role and the second set of users associated with the role, wherein the role is associated with the workflow step, and wherein the role is a reassigned role.

15. The computer-implemented system of claim 14, wherein the reassigned role is associated with a reassignment indicator.

16. The computer-implemented system of claim 14, wherein executing the workflow step according to a role and the second set of users associated with the role, comprises:
identifying a workflow ID associated with the current workflow;
accessing, at the persisted storage, a reassignment repository, wherein the reassignment repository comprises a plurality of reassignments, wherein each reassignment associated with a workflow ID corresponding to a workflow with which the reassignment is associated, wherein each reassignment is associated with a reassigned role; and wherein the reassigned role is associated with a second set of users;
selecting, the reassignment associated with the same workflow ID as the workflow ID associated with the current workflow; and
executing the workflow step according to the role and the second set of users associated with the selected reassignment.

17. A non-transitory computer-readable medium storing instructions which, when executed, cause at least one processor to perform operations comprising:
executing, at runtime, a plurality of operations defined in a listing of workflow steps associated with a current workflow, wherein each step is associated with a role associated with the execution of the step, and wherein executing the plurality of operations comprises:
identifying a workflow step from the listing of workflow steps;
determining whether the role associated with the workflow step is a reassigned role based on an reassignment indicator persisted in a memory associated with the role;
in response to the role not being associated with a reassignment indicator, executing the workflow step using a first set of users associated with the role; and
in response to the role being associated with a reassignment indicator, identifying a second set of users defined in the memory as a reassigned set of users and executing the workflow step using the second set of users;
wherein, at design time, at least one role is reassigned by:
identifying a current workflow, wherein the current workflow associated with at least one workflow step, and wherein each workflow step associated with at least one role and a set of users assigned to the role;
providing for presentation to a user interface (UI), a listing of the workflow steps associated with the identified current workflow, wherein at least one role is associated with each workflow step, and wherein each role is assigned a first set of users;
identifying, via the UI, a reassigned role, wherein the reassigned role is associated with at least one workflow step from the listing of the workflow steps, and wherein the reassigned role is reassigned by assigning a second set of users to the role to replace the first set of users that is associated with the role; and
associating, at a persisted storage, the reassigned role with the corresponding second set of users.

18. The non-transitory, computer-readable medium of claim 17, wherein the assigning a second set of users to the role to replace the first set of users that is associated with the role comprises adding or deleting at least one user from the first set of users.

19. The non-transitory, computer-readable medium of claim 17, wherein the assigning a second set of users to the role to replace the first set of users that is associated with the role comprises explicitly identifying the first set of users as the second set of users.

20. The non-transitory, computer-readable medium of claim 17, wherein executing the listing of the workflow steps associated with the current workflow comprises:
identifying each workflow step from the listing of workflow steps;
executing the workflow step according to a role and the first set of users associated with the role, wherein the role is associated with the workflow step, and wherein the role is not a reassigned role; and
executing the workflow step according to a role and the second set of users associated with the role, wherein the role is associated with the workflow step, and wherein the role is a reassigned role.
